(19) United States
(12) Patent Application Publication
(10) Pub. No.: US 2009/0068060 A1
(43) Pub. Date: Mar. 12, 2009

(54) Corrosion Monitor

(76) Inventors: Michael J. Alfermann, Washington, MO (US); Michael D. Kirn, Chesterfield, MO (US); David L. Royse, Wildwood, MO (US); Richard L. Ulrich, Manchester, MO (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 12/147,926

(22) Filed: Jun. 27, 2008

Related U.S. Application Data
(60) Provisional application No. 60/946,628, filed on Jun. 27, 2007.

(51) Int. Cl. G01N 17/00

(52) U.S. Cl. 422/53

(57) ABSTRACT

An apparatus for monitoring corrosion in a pressurized system such as a water-based fire protection system comprising a corrosion monitor mounted within a section of the system containing fluid, wherein the corrosion monitor comprises a surface comprising at least one point of weakness wherein corrosion of a point of weakness causes a change in pressure in an interior chamber of the monitor, which change can be to provide a signal alerting monitoring personnel.

### CROSS REFERENCE TO RELATED APPLICATIONS

This Application claims benefit of U.S. Provisional Patent Application Ser. No. 60/946,628, filed Jun. 27, 2007, the entire disclosure of which is herein incorporated by reference.

### BACKGROUND OF THE INVENTION

1. Field of the Invention

This disclosure relates to the field of corrosion detectors for pipes. In particular, to corrosion monitors with points of weakness present in the monitor and that are linked to automatic indicators.

2. Description of Related Art

To fight fires in modern buildings, firefighters use a wide variety of tools but are also regularly aided by systems within the building. Modem buildings almost universally include water-based fire protection systems to control or extinguish fires. Fire sprinkler systems generally follow a fairly standardized principle. A liquid firefighting material (generally water) is maintained in a series of pipes, generally under pressure, which are arranged throughout all areas of the building. In a wet pipe system, water is actually stored within the pipes, whereas in a dry pipe system, water is stored external to the building while the pipes contained pressurized air, nitrogen, or other gas. Attached to these pipes are various sprinklers which, when activated, will spray the liquid into a predetermined area. When a fire situation is detected, sprinklers on the pipe structure are activated by heat which then spray water. This activation is generally performed by a heat sensitive element, an integral part of the sprinkler which is activated by the heat from the fire. Generally, each sprinkler with its own heat sensitive element is activated independent of all other sprinklers. When a particular sprinkler is activated, the liquid in the pipes is dispensed by the sprinkler to a predetermined location. This action dispenses the liquid on the fire and serves to control or extinguish the fire.

The most common liquid used in fire protection systems is water because it is readily available, non-toxic, and quite effective in firefighting. Water, however, is an electrolyte which can enable electrochemical corrosion to occur where metal and oxygen are also present. Further, the water used in these systems is generally not pure and can contain a multitude of dissolved solids, water treatment chemicals, and microorganisms. These impurities can contribute to corrosion, including microbiologically induced corrosion, damaging pipes or other components that make up the water-based fire protection system when the system is prepared and “armed” awaiting a possible fire situation. The presence of trapped air (particularly the oxygen in the air) and how active a system is (how often it is drained and filled) will also contribute significantly to corrosion and its damaging effects in water-based fire protection systems.

The degradation of components, particularly metal piping, in water-based fire protection systems and/or deposition of materials within these systems can result in their failure to perform as intended and eventually to fail to constrain water, air, or other substances present within them. In particular, the pipes may fail leading to an unintended release of liquid which can be disastrous. This failure can result in damage to the building, building infrastructure, or objects in the building (such as electronic equipment, artifacts, finished goods, or other items).

Dry pipe systems are especially prone to corrosion. While water is not purposefully stored in the dry pipe region and it is often attempted to be purposefully eliminated, water will often be present in the pipe due to imperfect drainage of water or as a result of water condensing from air in the system. It is believed that most corrosion occurs where water and air (particularly oxygen) together contact metallic surfaces; therefore one of the methods used to control corrosion is by elimination of water. Because the air-filled pipes in a dry pipe system generally contain numerous water puddles left over from previous activations, testing, or operations of the sprinkler system, corrosion is thought to be especially likely at the many boundaries between such puddles and the air. Such boundaries are less prevalent in wet pipe systems, in which the goal is to completely fill the pipe with water and eliminate air. However, it is generally not possible to completely eliminate all air, as even if air is removed from the system, which is often not the case, there can be air pockets and air-water boundaries. Further, every time a water-based fire protection system is drained and refilled, the introduction of fresh water will usually lead to an increase in oxygen in the system, which can also contribute to corrosion. It is therefore desirable for a corrosion monitor to be able to monitor a dry pipe or wet pipe system.

Generally, examination of a water-based fire protection system's pipes for corrosion could only occur when the system was drained or out of service. Visual inspection generally requires an empty pipe for service personnel to make visual observations. Further, other types of monitoring devices would require an access point into the water-based fire protection system, which could not be opened to examine when the system was full of fluid as the fluid would escape, either resulting in a water deluge or triggering water to fill the pipes. This can be particularly problematic when the liquid is maintained under pressure as is the case in wet pipe water-based fire protection systems.

Many current tests require the removal from the pipe of something which was within the pipe to determine the pipe's status or relay an accelerated rate of corrosion. These items are often referred to as “test coupons” and could be small patches or panels of particular materials which may express certain properties when exposed to various conditions or may be constructed of materials used in the system to directly show that material's degradation. To determine if the water-based fire protection system is still functional and not overly corroded, the test coupon is exposed to the same conditions as a pipe by being placed in the system. One form of such coupon exposure places the coupon directly in the piping. When the system is drained, the coupon is removed and its degradation or buildup can be directly observed and/or evaluated by a laboratory. The test coupon is then generally replaced by a similar test coupon prior to the fluid being returned. Once a certain level of corrosion or buildup is detected, corrective measures may be introduced or maintenance may be performed to keep the water-based fire protection system functional. This current system is problematic in that in order to learn about corrosion in the pipe, the entire system must be drained; if corrosion is not at a concerning level and repairs are unnecessary, the draining is merely a great waste of water resources, very costly, and an inconvenient precaution. Another problem inherent in draining for coupon analysis arises when the coupon is reinserted and the system refilled. At that point, the coupon is potentially monitoring an entirely new set of conditions (chemical and biological) in the water.

There are some systems which do not require drainage for coupon analysis, but which install coupons in corrosion monitoring systems that are either effectively a part of the water-based fire protection system, or isolated from it, depending on control exercised by maintenance personnel. One such station is described in U.S. application Ser. No. 10/851,260, the entire disclosure of which is incorporated herein by reference.

It is believed that most corrosion occurs at the liquid-gas interface; in other words, the location in the pipe where water, air, and the pipe material can interact. Current coupon systems may not correctly analyze the liquid/gas interface, or may not even have access to an interface even if one is present elsewhere in the system. Coupons may project into the pipe such that they only interact with water, or only with gas. Because much corrosion and other degradation is believed to occur at the liquid/gas interface, coupons that do not interact with this interface may not accurately reflect the highest rate of corrosion occurring within the pipe. It is therefore desirable that a corrosion monitor interact with the liquid/gas interface.

Yet another problem with current coupon systems (both in the pipe and in an isolated monitoring system) is the great amount of manhours required to analyze coupons for corrosion. In order to observe coupon corrosion, personnel must access the coupon installation, usually in the walls, ceilings, and other difficult to access portions of a building; isolate the coupon, either by draining the system or isolating a corrosion monitoring system; tediously remove the coupons; take them to a lab for analysis; return to the building to reinstall the same or new coupons; and restore the normal fill of water. All of these steps are expensive and tedious. Moreover, they are usually commenced upon a mere suspicion of corrosion or on a regular maintenance schedule. It is therefore desirable for a corrosion monitor to indicate corrosion at an accessible location and to not require draining, so that more tedious measures need only be taken upon the actual occurrence or heightened concern that corrosion is actually present.

Some corrosion monitoring systems provide relatively accessible corrosion indication, but these systems also have problems. Some of the systems use a pod containing desiccated dye, which becomes rehydrated upon corrosion of the barrier between the pod and the water in the pipe. The pod is situated such that operators reviewing the corrosion monitor can see the rehydrated dye. The first problem with this system is that it requires operators to access and manually scan the pods, which introduces the problems of human error, inefficiency, and the potential that corrosion may occur long before an operator inspects the pod or at a place not easily viewed. It is therefore desirable for a corrosion monitoring system to produce an automatic alarm or other signal that is instantly receivable by operators in their ordinary course of operation.

Second, the pods are of no use if air, rather than water, enters the breach caused by corrosion. Because the sprinkler system is under pressure, usually any breach that permits the movement of air will result in general venting of that air, rather than entry of any water or air into the pod. If the pod is not oriented such that gravity or pressure would cause water to enter, that is, if it is on the “top” of a partially empty pipe, the pod may fail to indicate any corrosion. This failure is more likely in dry pipe systems, particularly those that use nitrogen and other means to minimize residual water and make it more likely that a pod would be breached by only air. It is therefore desirable for a corrosion monitoring system to respond to breaches that cause both air and water to move.

### SUMMARY OF THE INVENTION

The following is a summary of the invention in order to provide a basic understanding of some of the aspects of the invention. This summary is not intended to identify key or critical elements of the invention or to delineate the scope of the invention. The sole purpose of this section is to present some concepts of the invention in a simplified form as a prelude to the more detailed description that is presented later.

Disclosed herein is an apparatus for monitoring corrosion in a water-based fire protection system comprising a corrosion monitor mounted within a section of pipe containing fluid, wherein the corrosion monitor comprises a surface comprising points of weakness, and wherein the points of weakness are distributed across a length of the monitor. In further embodiments of that apparatus, the points of weakness may be threads, scorings, or perforations. Also disclosed is an apparatus wherein the corrosion monitor further comprises a vacant interior chamber, wherein the chamber receives the air, the fluid, or a combination of the air and the fluid through the surface upon corrosion of a point of weakness.

Disclosed herein is also any pressure indicator which is capable of noting the receipt by the chamber. In an embodiment, that pressure indicator comprises a piezoelectric or electromechanical switch, a pressure transducer, a pressure sensing probe, other pressure sensors known to those of ordinary skill in the art, or any combination of pressure sensors capable of monitoring the pressure within the chamber. The indicator may also provide an notification upon receipt.

In an embodiment, the pipe in which the apparatus is installed is a component of a corrosion monitoring station, wherein the coupon can be removed for testing without draining the water-based fire protection system. Alternatively, that pipe is a portion of a main or branch line.

In an embodiment, the water-based fire protection system is a dry pipe system. In an alternative embodiment, the water-based fire protection system is a wet pipe system.

### BRIEF DESCRIPTION OF THE DRAWINGS

FIG. 1 provides cross-sectional views of four embodiments of a corrosion monitor: 1A depicts a helically grooved corrosion monitor, 1B a perforated corrosion monitor, 1C a grooved corrosion monitor, and 1D a thin-walled corrosion monitor.

FIG. 2 provides a cross-sectional view of another, helically threaded embodiment of a corrosion monitor.

FIG. 3 provides two views (3A and 3B) of one embodiment of a pressure indicator.

FIG. 4 provides a cross-sectional view of one embodiment of a corrosion monitor installed in a pipe.

FIG. 5 provides a cross-sectional view of one embodiment of corrosion monitors installed in a corrosion monitoring system.

### DETAILED DESCRIPTION OF THE PREFERRED EMBODIMENT(S)

The following detailed description illustrates the invention by way of example and not by way of limitation.

In order to allow for monitoring of the conditions inside a water-based fire protection system (whether wet or dry pipe) without having to significantly drain the system and to improve corrosion monitoring generally, there are described herein embodiments of a corrosion monitor (209). The corrosion monitor (209) may be used in a dry pipe, wet pipe, or other water-based fire protection system and for purposes of this disclosure the system will be generally referred to as a water-based fire protection system regardless of type.

Although the disclosure herein primarily references the monitoring of fire sprinkler pipes, this is not meant to be a limitation on the use of the monitoring system disclosed herein. This monitoring system could be applied to any piping or liquid conveyance system where corrosion may occur and access is difficult. This monitoring system can also be applied to any location within a piping system, including corrosion monitoring stations and pipes. Embodiments of such applications are described herein.

One of ordinary skill in the art would understand that such a corrosion monitor could be used in any type of fire detection or reaction system where corrosion would need to be detected and whereby a breach would result in a pressure change such as, but not limited to, chemical-based fire protection systems. However, for ease of discussion, this document will presume that the corrosion monitor is in use in a water-based fire protection systems.

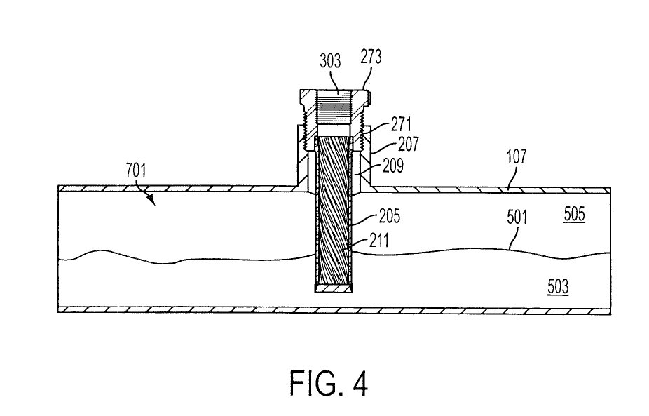

A corrosion monitor (209) will generally be attached to the pipe (107) or other structure being monitored via attachment points (207), which will generally be holes through the outer surface of a pipe (107) allowing access to its internal volume. An embodiment of such attachment is shown in FIG. 4. These holes (207) will each be bordered by a connector of some form (such as screw threads) (271) which can receive a cap or plug (273), which may or may not be attached to the corrosion monitor (209), to be attached thereto sealing the hole such as through the use of mating threads. Operative connector (303) also permits connection of the corrosion monitor (209) to a pressure indicator (301) or other pristine detection system or means. These attachment points (207) can be placed at any location around the pipe (107) so that they extend into the pipe (107) at any angle.

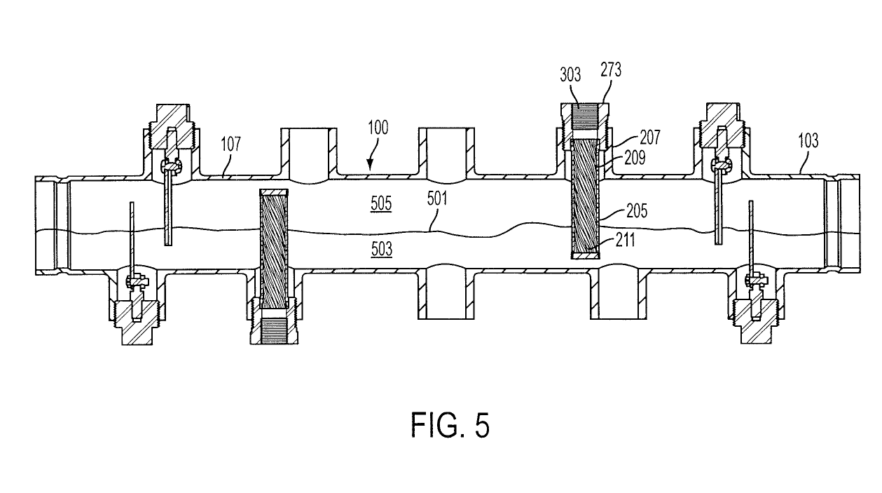

It is generally preferred that the monitor(s) (209) be attachable from underneath or above the pipe (107) or other structure to be monitored, as is shown in FIG. 5. In an embodiment, the length of the corrosion monitor (209) is longer than the internal radius of the pipe (107). In this way, if two monitors (209) extend in opposing directions from the top and bottom of the pipe (107), at least one will cover all heights within the pipe (107) and extend across the cross section of the liquid/gas interface (501) if a consistent interface exists, regardless of position. Such coverage is obtained since water, if present, will generally find a fixed level between the top and bottom of the pipe (107), The monitor (209) thus solves the problem of current corrosion monitoring systems which require careful positioning for the coupons or pod to be underwater or at the interface (501); the length and orientation of the monitor(s) (209) facilitates interaction with the liquid/gas interface (501). Please note that the location of the interface (501) shown in the FIGS. is illustrative and emphasized for explanatory purposes. Generally, the level will be significantly lower or higher depending on system type.

The corrosion monitor (209) should be arranged so as to span any likely liquid/gas interface (501) present between liquid (503) and gas (505) within the pipe (107), as that is believed to be the most likely place for corrosion to occur. In this way, the monitor (209) will extend from the cap or plug (273) into the pipe's (107) internal volume (701). Preferably, the corrosion monitor (209) is suspended within the internal volume so as to have only minimal contact with the pipe's (107) inner surfaces. It is more preferred that the corrosion monitor (209) only have contact with the cap or plug (273). It is also generally preferred that when the cap or plug (273) is removed, the corrosion monitor (209) is pulled through the hole.

Appropriate monitor (209) interaction with the liquid/gas interface (501) is facilitated by points of weakness (211) which are present on the monitor (209). The term “points of weakness” encompasses any means known in the art to create a relatively thin monitor (209) surface at the liquid/gas interface or other structure which is relatively more susceptible to corrosion of interest than the rest of the structure or the monitor (209). A point of weakness will generally also be more susceptible to structural failure from corrosion than the material of the pipe (107) in which the monitor (209) is used. For example, a point of weakness may comprise a steel wall of 1 mm thickness used in a pipe (107) of 10 mm thickness. In such a system it would be expected that the point of weakness would fail prior to failure of the pipe (107).

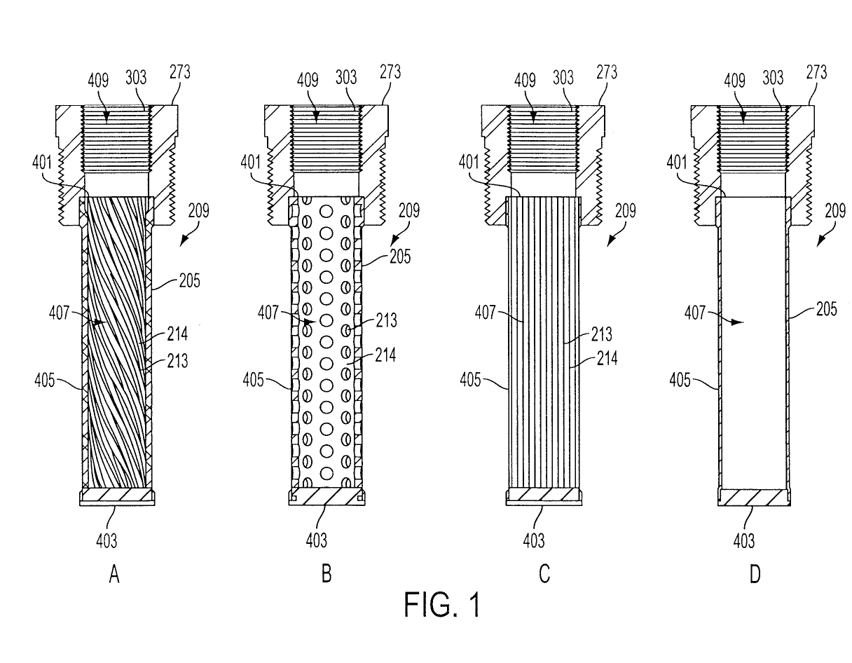

In general structure, the monitor (209) will usually comprise a distal end (401) which will often be open, a proximal end (403) which will generally be sealed, and include an outer wall (405) extending from the distal (401) to proximal (403) ends. The structures in FIG. 1 are generally cylindrical, but that is by no means required. Further, the outer wall (405) between the ends will generally enclose a vacant interior chamber (407). To provide for a point of weakness at the air/gas interface, regardless of where it may be within the pipe, points of weakness will generally be distributed along the length of the monitor (209). That is that at any point along the surface of the outer wall (405) of the monitor (209), there will generally be an intersection, at some point, with a point of weakness.

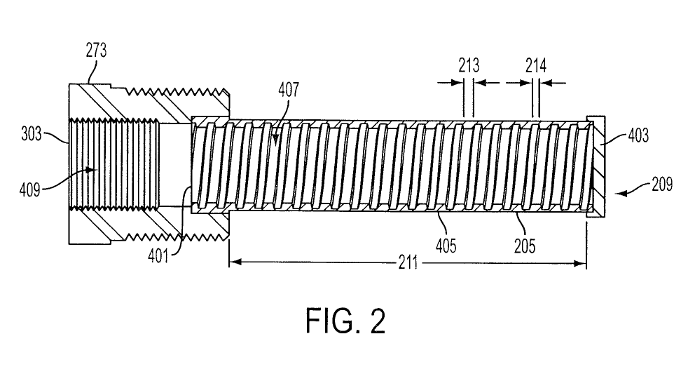

In an embodiment, this arrangement may be accomplished by having the entire monitor (209) outer wall (405) surface be substantially thin, as shown in FIG. 1D. However, in an alternative embodiment, thicker areas may be necessary as the monitor (209) would be in danger of collapse from the pipe's internal pressure if it is manufactured entirely of weaker material. Where it is desirable to strengthen the monitor (209) against such collapse in the form of thicker monitor (209) regions, relative points of weakness (213) may consist of threads, perforations, grooves, scoring lines, or any other means or combination of means known in the art whereby certain points on the monitor (209) are constructed of relatively thinner material than others. Alternative grooved embodiments are shown in FIGS. 1A and 1C, in which points of weakness (213) are interspersed between thicker regions (214). A perforated embodiment with selective points of weakness (213) is shown in FIG. 1B. A threaded embodiment with selective points of weakness (213) is shown in FIG. 2. As can be seen, points of weakness (213) can extend helically, circularly, or linearly along the length of the monitor depending on embodiment. Any embodiment with points of weakness (213) may be formed of a single piece of material with additional material added or removed to create points of weakness (213) or thicker regions (214), respectively. Alternatively, any such embodiment may be formed of a first piece of material with hollows or material otherwise removed which is attached to another solid piece to form a combined piece with relative points of weakness (213). Still further, in an alternative embodiment, the proximal end (403) may also include points of weakness, though such construction is generally unnecessary.

The points of weakness (213) may either be on the exterior of the monitor (209) or interior to a casing (205), as shown in the FIGS depending on the desired arrangement and form of manufacture. In either case, the points of weakness (213) form a portion of the outer wall (405). Regardless of the manner of placement, these points of weakness (213) will provide for at least some points along the outer wall (405) of the monitor (209) which are sufficiently weak to breach and allow water or air to penetrate into the vacant space (407) when corrosion has reached a level which is desired to initiate a signal of alarm, the weakness causing a through the wall failure of the monitor (209) as the point of weakness (313) corrodes to the point of structural collapse or compromise.

In a further embodiment, shown in FIGS. 1A and 2, points of weakness (213) run substantially helically in the monitor (209) portion between the point of attachment (207) and the end in the pipe (107). This orientation and continuity along the monitor (209) shaft ensures that no matter the monitor's (209) orientation or degree of protrusion into the pipe (107), a liquid/gas interface will generally interact with a point of weakness (213). Any sort of point of weakness (211) may run substantially helically as, for example, is shown by the generally helical distribution of openings in FIG. 1B. Such a helical arrangement permits comparison of points of weakness (213) at the liquid/gas interface with points (213) not at that interface that may be therefore subject to less corrosion.

The exact depth of a point of weakness (213), either generally or in relation to a thicker portion (214), may depend on the rate of likely corrosion in the given pipe environment and the conservatism with which the operator wishes to monitor for corrosion. The point of weakness (213) is preferably thinner than the structure of the pipe (107) to ensure structural breach of the monitor (209) before the pipe (107) would fail to perform as intended or fail to have sufficient structural integrity to contain liquid (503). If notice of corrosion is desired sooner rather than later, the point of weakness (213) should be thinner than if more corrosion is permissible. The thinness of the point of weakness (213) may also be keyed to applicable industry requirements for corrosion monitoring.

As should be apparent from the embodiments of FIG. 1, generally points of weakness (213) will be distributed across the outer surface (405) of the monitor (209) in such a fashion so that any plane positioned perpendicular to the outer wall (405) will intersect at least one point of weakness (213). In such an arrangement, no matter the location of a liquid /gas interface (501) in the monitored pipe (107), if the liquid/gas interface (501) intersects the monitor (209) it will intersect a point of weakness (213).

In an embodiment, encased within the portion of the monitor (209) hosting points of weakness (211) is a vacant chamber (407). The chamber (407) is generally maintained at standard atmospheric pressure or may even be maintained at a vacuum or other pressure. Upon corrosion of any point of weakness (211) leading to formation of a fluid gap in the outer wall (405), water (507) and/or air from the pressurized pipe (107) rushes into that vacant chamber (407) via the breach, and only into that vacant chamber (407). In an embodiment, such corrosion would usually take place at one or more points of weakness (213). The mix of liquid (503) and/or gas (505) depends upon the location of the monitor (209) breach relative to the liquid/gas interface (501). Thus, the monitor (209) acts as an anticipatory and contained pipe (107) leak.

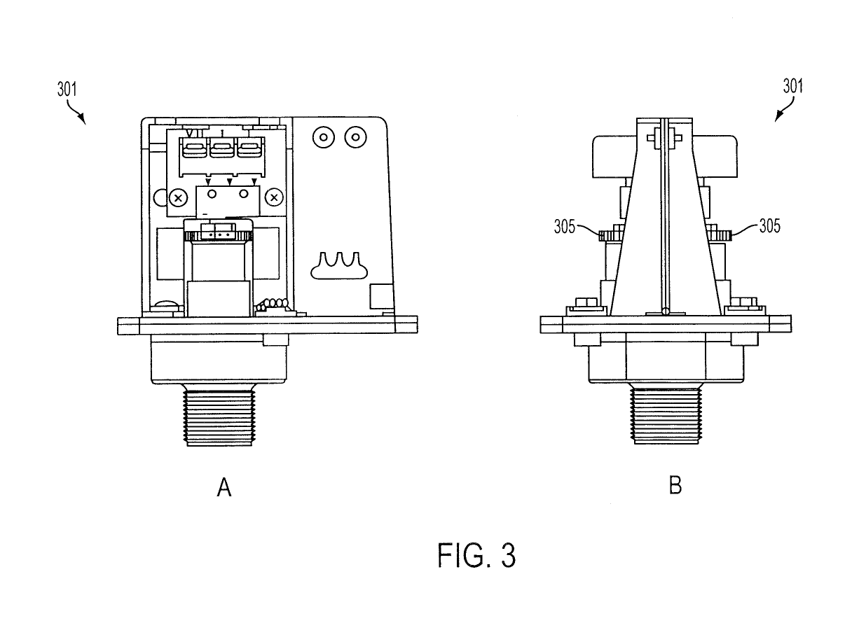

In an embodiment, the monitors (209) are operatively attached to an indicator (301) capable of detecting and indicating breach of the vacant interior (407), such as a pressure indicator (301). An embodiment of such a pressure indicator (301) is shown in FIGS. 3A and 3B. Such attachment requires an operative connection (303) between the indicator (301) and the monitor (209), which may be electrical, fluid, rely on vibration, rely on pressure, or use any other means to communicate the monitor (209) status to the indicator (301). In an embodiment, the indicator (301) screws into the plug section (273) of the monitor (209) at threads (303), shown in FIGS. 1, 2, 4, and 5, the lower portion of which is attached to the monitor (209) as the distal end (401) of the monitor (209) is open, this allows free fluid flow between the interior chamber (407) and the internal area (409) of the plug (273) to which the indicator (301) is attached. Therefore, should the pressure change in the interior chamber (407), such change would be detected by the indicator (301).

In an embodiment, the indicator (301) screens for monitor (209) breach and influx of liquid (503), gas (505), or both. Since generally such a breach causes the pressure in the interior chamber (407) to change in an amount detectable by the indicator (301) a pressure indicator can be used. However, any type of indicator (301) capable of detecting a breach could be used. This includes, but is not limited to, ultrasound probes, resistive probes, capacitive probes, inductive probes, light probes, float switches, flow switches, or any combination of these or other means. In the depicted embodiment, the pressure change provides for an electromechanical detection of the pressure change (such as by movement of a portion of the indicator (301)). This change is detectable and can be transmitted to a remote location using any type of transmission methodology known to those of ordinary skill such as, but not limited to, wired or wireless communication. In a further embodiment, such a pressure indicator (301) may be, but is not limited to, a piezoelectric or electromechanical switch, a pressure transducer, a pressure monitoring probe, or any other similar device or means known to one of ordinary skill in the art. Such an indicator (301) may create an electric signal in response to the mechanical stress exerted upon the indicator (301) by the change in pressure within the interior chamber (407).

In an embodiment, the indicator (301) will provide some sort of notification to remote operators that the monitor (209) integrity has failed, in response to the change in pressure and influx of air or water. In a further embodiment, such notification may be provided by, audio signals, visual signals, or both, which are digitally or electrically conveyed from the indicator (301) to an operator station. In an embodiment using the piezoelectric or electromechanical switch (301), this notification would be derived from the electric signal created in response to the mechanical stress. This has the advantage of providing notification to the location where operators are already present, removing the requirement for operators to patrol indicators that are attached to the pipe (107). As explained above, current indicators may not reflect corrosion that permits air to escape, be inconveniently located, and require replacement upon interaction with water; the device's (301) notification capability assists with these difficulties.

In an embodiment, the indicator (301) may also be calibrated to provide notification only at a certain level of change to the monitor (209) (such as pressure change), in order to decrease unnecessary notification. In an embodiment, such calibration may be achieved via adjustment knobs (305).

One or more corrosion monitors (209) may be installed at any location within the water-based fire protection system or other system to be monitored. In an embodiment shown in FIG. 4, the corrosion monitor (209) may be installed in the water-based fire protection system pipe (107) itself, such as in the main or a branch line. If so installed, corrosion monitors (209) and any indicator (301) report on the actual conditions within that piping (107) in the manner disclosed above. Unlike current coupon systems, which require draining of the piping system in order to safely remove and analyze the coupon, reporting by the corrosion monitor (209) and indicator (301) does not require the piping to be drained. Rather, the corrosion monitor (209) and indicator (301) may remotely notify an operator of a breach without requiring draining. The operator can drain the system at an opportune and cost-effective time, taking into account the number of indicators (301) that have indicated a problem, the extent of corrosion required to create a breach of the corrosion monitor (209), cost and inconvenience of draining, and any other factors. If the monitor (209) is in use in a dry pipe system, the pressure may only need to be released without any draining at all.

Still further, since the indicator (301) can also act to effectively seal the combined interior chamber (407) and the internal area (409), when a breach occurs, the relatively small internal area inside the monitor (209) may quickly reach equilibrium with the pressure in the pipe (107) preventing the breach in the monitor (209) from allowing fluid to escape the system.

In addition, because the corrosion monitor (209) does not require draining in order to notify an operator of concerning situations, the corrosion monitor (209) disclosed herein may be part of a closed system that more readily identifies issues than current coupon systems. When a pipe (107) system is drained for coupon analysis, and the same or new coupons are reinserted and the pipe (107) system refilled, the coupons are interacting with water and air with potentially very different properties than the water and air present before the drain and replacement. Factors of water chemistry and/or biology may be very different after draining than before. Further, the very introduction of new fresh water may result in an increase in oxygen in the system and a potential increase in a corrosion rate.

In contrast, because the corrosion monitor (209) disclosed herein does not require draining for analysis, the closed system being monitored is not disrupted, and the monitoring remains accurate and keyed to the piping system contents. Specifically, should an indicator be triggered by corrosion, a corrosion inhibitive material may be added to the water without full system draining. Remaining monitors can then be checked for possible additional failure, or, if none occurs, operators may be reassured that the threat of corrosion may have been abated.

Alternatively, upon indication by the indicator (301), the monitor (209) can be removed and analyzed, and the problem addressed. A new or repaired corrosion monitor (209) can then be installed, thus restoring the original structural integrity of the system. The water-based fire protection system can then again be filled with fluid, whether liquid, in the case of a wet pipe system, or air, in the case of a dry pipe system. Thus, the corrosion monitor (209) and indicator (301) enables water-based fire protection system personnel to have more confidence that monitors (209) are only accessed when an actual problem likely exists.

In an embodiment, one or more corrosion monitors (209) may be installed in a corrosion monitoring station (100) rather than the water-based fire protection system piping itself. FIG. 5 discloses one embodiment of such installation in a corrosion monitoring station (100). Attachment or access points (207) may be found in the coupon rack (103) or any other portion of the corrosion monitoring station (100). The pipe (107) forming the rack (103) of the corrosion monitoring station (100) is preferably substantially similar to, or more preferably the same as, the construction of the sprinkler piping (107), so that corrosion monitors (209) and the indicator (301) respond to conditions representative of those in the sprinkler piping (107).

To remove the corrosion monitors (209) from the coupon rack (103), isolation valves separating the corrosion monitoring station (100) from the pipe (107) will generally be closed to isolate the internal volume of the coupon rack (103), and then the coupon rack (103) is drained of fluid using a drain valve or a similar structure. In this way, only the fluid within the coupon rack (103) is removed, leading to no outages of service of the water-based fire protection system as the draining of the coupon rack (103) does not effect the remaining system which can continue to function uninterrupted. Further, due to the limited size of the coupon rack (103), the coupon rack (103) may be drained into a bucket or similar hand portable object. Corrosion monitors (209) in the coupon rack (103) may thus be removed, analyzed, and replaced without draining the entire water-based fire protection system.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. An apparatus for monitoring corrosion in a water-based fire protection system, the apparatus comprising:
a section of pipe containing fluid;
a corrosion monitor mounted within said section of pipe;
wherein the corrosion monitor comprises a surface including a plurality of points of weakness; and
wherein said points of weakness are distributed across a length of the monitor.

2. The apparatus of claim 1 wherein said points of weakness comprise grooves within threads.

3. The apparatus of claim 1 wherein said points of weakness comprise scorings.

4. The apparatus of claim 1 wherein said points of weakness comprise perforations.

5. The apparatus of claim 1 wherein said corrosion monitor further comprises a vacant interior chamber,

6. The apparatus of claim 5 wherein the chamber receives gas upon corrosion of a point of weakness.

7. The apparatus of claim 5 wherein the chamber receives liquid upon corrosion of a point of weakness.

8. The apparatus of claim 5 wherein the chamber receives a fluid upon corrosion of a point of weakness.

9. The apparatus of claim 5 further comprising an indicator capable of detecting that a breach has developed in a point of weakness.

10. The apparatus of claim 9 wherein said indicator is a pressure indicator capable of recognizing a change in pressure within said chamber.

11. The apparatus of claim 10 wherein said pressure indicator comprises at least one of a piezoelectric switch, an electromechanical switch, a pressure transducer, or a pressure sensing probe.

12. The apparatus of claim 10 wherein said pressure indicator issues a notification upon recognizing said change of pressure.

13. The apparatus of claim 1 wherein said section of pipe is a component of a corrosion monitoring station, wherein the corrosion monitor can be removed for testing without draining the water-based fire protection system.

14. The apparatus of claim 1 wherein said section of pipe is a portion of a main line.

15. The apparatus of claim 1 wherein said section of pipe is a portion of a branch line.

16. The apparatus of claim 1 wherein said water-based fire protection system is a dry pipe system.

17. The apparatus of claim 1 wherein said water-based fire protection system is a wet pipe system.

18. A corrosion monitor, the monitor comprising:
a distal end;
a proximal end spaced from said top,
an outer wall interconnecting said top and said bottom and enclosing a hollow interior, wherein said outer wall includes at least one point of weakness;
a connector, for allowing said corrosion monitor for being attached to a pipe; and
a pressure detector functionally coupled with said hollow interior such that said pressure detector can detect a change in pressure within said hollow interior when said outer wall is breached.

19. The monitor of claim 18 wherein said monitor is adapted for use in a water-based fire protection system.

20. The monitor of claim 18 wherein said monitor is adapted for use in a chemical-based fire protection system.
